(19) United States
(12) Patent Application Publication
(10) Pub. No.: US 2008/0037591 A1
(43) Pub. Date: Feb. 14, 2008

(54) Data recording and reproducing apparatus

(75) Inventors: Hirofumi Mori, Koganei-shi (JP); Tatsunori Saito, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/645,045

(22) Filed: Dec. 22, 2006

(30) Foreign Application Priority Data
Aug. 11, 2006 (JP) 2006-220370

(51) Int. Cl. H04J 3/06

(52) U.S. Cl. 370/503; 370/252

(57) ABSTRACT

A data recording and reproducing apparatus includes a separation unit configured to separate a program clock reference (PCR) from a received transport stream packet (TS packet), a counter to count system time clocks (STCs) generated corresponding to the clock frequency, a comparison unit configured to compare the PCR with the STC to output a difference between the PCR and the STC as a control signal, a first control unit configured to control the clock frequency on the basis of the control signal and to output information on a control parameter and a control timing for controlling the clock frequency, a second control unit configured to generate a system time clock packet (STC packet) containing the control parameter and the control timing as control information, and a recording unit configured to record the TS packet and the STC packet.

### CROSS-REFERENCE TO RELATED APPLICATIONS

This application is based upon and claims the benefit of priority from prior Japanese Patent Application No. 2006-220370, filed Aug. 11, 2006, the entire contents of which are incorporated herein by reference.

### BACKGROUND OF THE INVENTION

1. Field of the Invention

The present invention relates to data recording and reproducing apparatuses.

2. Description of the Related Art

For example, MPEG-2 systems conventionally multiplex coded streams in packets of transport stream (TS) for transmission. In the MPEG-2 system, what is called TS packets each with a fixed length of 188 bytes are arranged in TS. TS packets transmit attribute information indicating the type of bitstream constructed by video information and audio information, bitstreams, and reference clock information for synchronization between media which is called a program clock reference (PCR). Upon receiving TS packets, a receiver generates a system time clock (STC) as a control signal on the basis of PCR to synchronize a clock of a receiving decoder with a clock of a transmitting encoder. To record and reproduce TS packets, the receiver similarly needs to execute synchronization using STC. However, extracting and recording only the TS packets required for reproduction may break the relationship between PCR and STC. This may prevent a recorded reproduction clock from being restored.

Japanese Patent No. 3592186 describes a data recording and reproducing apparatus that records the arrival times of TS packets to restore reproduction timings. However, this data recording and reproducing apparatus requires input timings for TS packets to be controlled. Consequently, this processing delay may reduce the accuracy with which the reproduction timing is restored.

### BRIEF SUMMARY OF THE INVENTION

An object of the present invention is to allow a receiver to record TS packets so that a recorded reproduction clock can be restored for reproduction.

According to a first aspect of the present invention, there is provided a data recording and reproducing apparatus includes: a separation unit configured to separate a program clock reference (PCR) from a received transport stream packet (TS packet); a counter to count system time clocks (STCs) generated corresponding to the clock frequency; a comparison unit configured to compare the PCR with the STC to output a difference between the PCR and the STC as a control signal; a first control unit configured to control the clock frequency on the basis of the control signal and to output information on a control parameter and a control timing for controlling the clock frequency; a second control unit configured to generate a system time clock packet (STC packet) containing the control parameter and the control timing as control information; and a recording unit configured to record the TS packet and the STC packet.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a data recording and reproducing apparatus in accordance with an embodiment.

FIG. 2 is a conceptual drawing illustrating how the data recording and reproducing apparatus in FIG. 1 records TS packets and STC packets.

FIG. 3 is a diagram showing an example of configuration of an STC packet used in the data recording and reproducing apparatus in FIG. 1.

FIG. 4 is a flowchart showing a recording process procedure performed by the data recording and reproducing apparatus in FIG. 1.

FIG. 5 is a flowchart showing a reproducing process procedure performed by the data recording and reproducing apparatus in FIG. 1.

### DETAILED DESCRIPTION OF THE INVENTION

An embodiment of the present invention will be described with reference to the drawings.

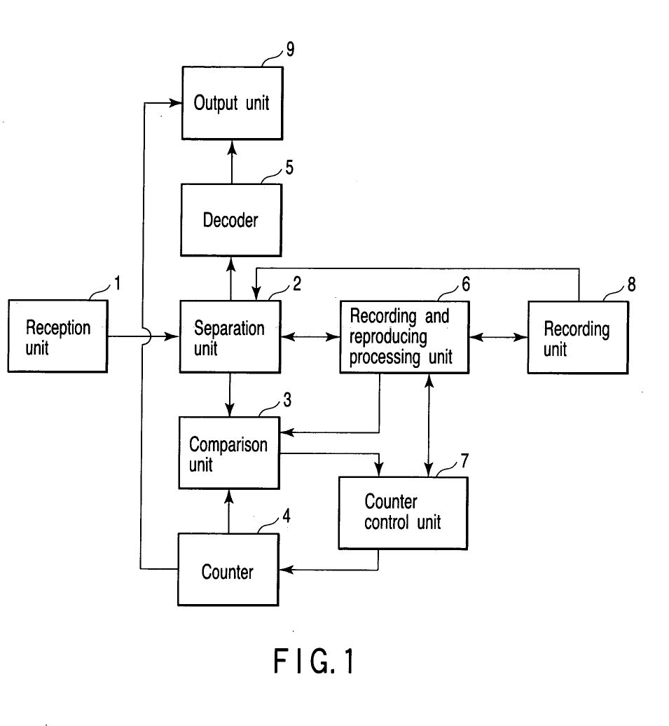

As shown in FIG. 1, a data recording and reproducing apparatus has a reception unit 1, a separation unit 2 connected to the reception unit 1, a comparison unit 3 connected to the separation unit 2, a counter 4 connected to the comparison unit 3, a decoder 5 connected to the separation unit 2, a recording and reproducing processing unit 6 connected to the separation unit 2 and the comparison unit 3, a counter control unit 7 connected to the comparison unit 3, the counter 4, and the recording and reproducing unit 6, a recording unit 8 connected to the separation unit 2 and the recording and reproducing unit 6, and an output unit 9 connected to the counter 4 and the decoder 5.

There will be described data recording performed by the data recording and reproducing apparatus in FIG. 1 hereinafter.

The reception unit 1 receives TS (transport stream) packets transmitted via a network. The separation unit 2 separates PCRs (program clock references) from the received TS packets and transfers them to the comparison unit 3. The separation unit 2 also transfers the TS packets to the recording and reproducing processing unit 6.

The comparison unit 3 compares each PCR with STC (system time clock) counted by the counter 4 and transfers the difference between PCR and STC to the counter control unit 7 as a control signal. The counter control unit 7 controls the clock frequency of the counter 4 in accordance with the control signal (difference between PCR and STC) to the difference approximate to ‘0’. The counter control unit 7 further transfers a control parameter and a control timing to the recording and reproducing processing unit 6 as control information.

The recording and reproducing processing unit 6 generates STC packets each containing the control information on the clock control of the counter 4 and transfers the STC packets to the recording unit 8 together with the TS packets.

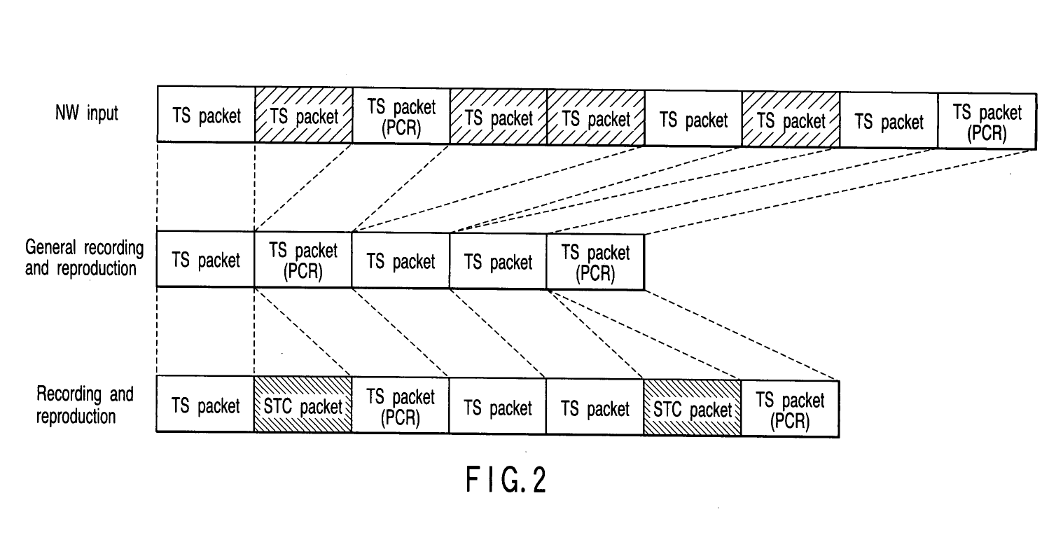

The recording unit 8 records the TS packets and STC packets so as to be arranged as shown at the bottom of FIG. 2. Specifically, TS packets each with a fixed length of 188 bytes are arranged in TS input via a network such as that shown at the top of FIG. 2. Some of the TS packets contain PCRs. Normally, TS packets for buffer control are removed, with only the required TS packets recorded in the recording unit 8, as shown in the middle of FIG. 2. However, omission of the TS packets for buffer control prevents the relationship between PCR and STC from being determined upon data reproduction. Accordingly, the data recording and reproducing apparatus in FIG. 1 places each 188-byte STC packet, in, for example, in front of each of the TS packets having PCRs shown in the middle of FIG. 2, as shown at the bottom of FIG. 2. The STC packet has control information (control parameter and control timing) for the TS packet having PCR.

The control parameter is a control voltage for a voltage-controlled crystal oscillator (VCXO) serving as a clock generator, the frequency dividing ratio of a frequency dividing circuit, or the like. The control parameter depends on the configuration of the clock generator.

The size of the STC packet is not limited to 188 bytes as described above. Instead of being placed in front of each TS packet with PCR, the STC packets may be recorded in a file different from that containing the TS packets. Alternatively, STC packets may be placed at control parameter change points corresponding to positions where the TS packets with PCRs are detected and at a fixed period.

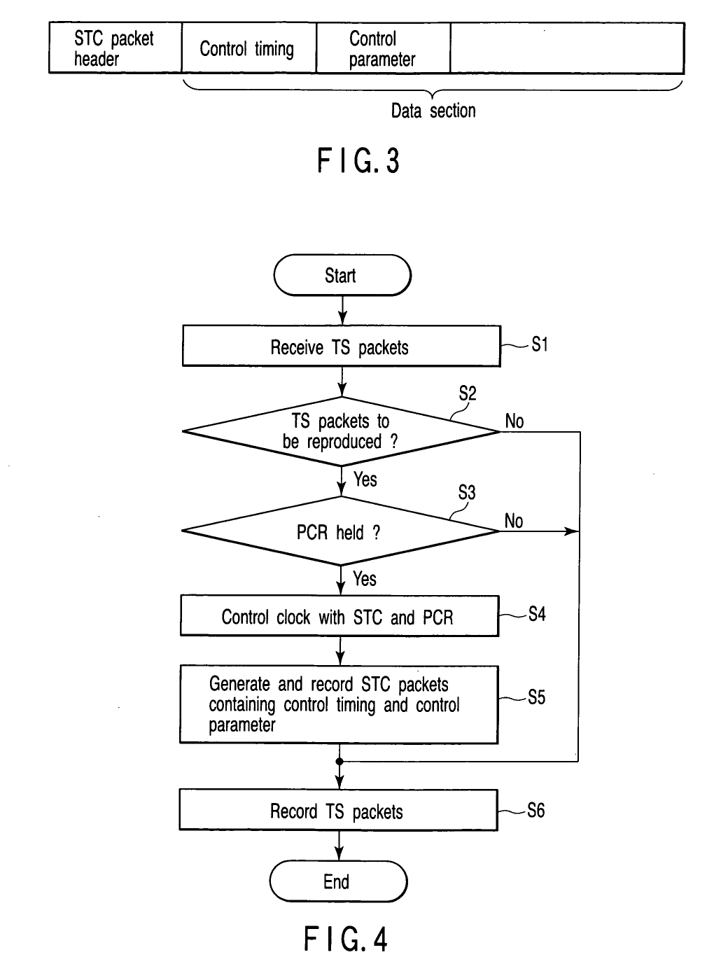

An example of configuration of the STC packet is shown in FIG. 3. The STC packet comprises an STC packet header and a data section. The data section contains at least the control timing and control parameter for STC.

With reference to the flowchart in FIG. 4, a further detailed description will be given of a recording process procedure performed by the data recording and reproducing apparatus in FIG. 1.

First, upon receiving TS packets transmitted via a network, the reception unit 1 transfers the received TS packet to the separation unit 2 (step S1). The separation unit 2 then determines whether or not the received TS packet is to be reproduced (step S2). If the received TS packet is to be reproduced (Yes in step S2), the process proceeds to step S3. Otherwise (No in step S2) the process proceeds to step S6.

In step S3, the separation unit 2 determines whether or not the received TS packet has PCR. If the received TS packet has PCR (Yes in step S3), the separation unit 2 transfers PCR to the comparison unit 3. The process then proceeds to step S4. Otherwise (No in step S3) the process proceeds to step S6.

In step S4, the comparison unit 3 generates a control signal corresponding to the difference between PCR transferred by the separation unit 2 and STC counted by the counter 4. The comparison unit 3 transfers the control signal to the counter control unit 7. The counter control unit 7 controls the clock frequency of the counter 4 on the basis of the control signal. The counter control unit 7 then transfers control information (control timing and control parameter) on the clock control of STC to the recording and reproducing processing unit 6.

The recording and reproducing processing unit 6 generates a STC packet containing the control information (control timing and control parameter) on the clock control of STC, and records the packet in the recording unit 8. The process proceeds to step S6 (step S5).

In step S6, the recording and reproducing processing unit 6 records the TS packet to be processed, in the recording unit 8.

Now, description will be given of data reproduction performed by the data recording and reproducing apparatus in FIG. 1.

The separation unit 2 reads TS packets and STC packets from the recording unit 8 and separates audio information and video information from the TS packets. The separation unit 2 transfers the information to the decoder 5. The read packets are arranged as shown at the bottom of FIG. 2 as previously described. The separated audio and video information and the STC packets are transferred to the recording and reproducing processing unit 6.

The recording and reproducing processing unit 6 transfers the control parameters in the STC packets to the counter control unit 7, while transferring the control timings to the comparison unit 3. The comparison unit 3 compares each of the transferred control timings with STC counted by the counter 4 to notify the counter control unit 7 of a setting timing for the control parameter.

Upon receiving the notification from the comparison unit 3, the counter control unit 7 updates the control parameter in accordance with the setting timing. On the basis of the resulting control parameter, the counter control unit 7 controls the clock frequency of the counter 4. This enables the counter 4 to be controlled using the same control timings and parameters as those for recording. As a result, a recorded reproduction clock can be restored.

The decoder 5 decodes the audio information and video information separated from the TS packets by the separation unit 2. The decoder 5 then sends the information to the output unit 9. The output unit 9 outputs videos and sounds at predetermined timings determined by comparing the output time with STC counted by the counter 4 for which the recorded reproduction clock has been restored as described above. For example, if coded video information is transferred to the decoder 5 by the separation unit 2, the decoder 5 decodes the video information and transfers the decoded videos and information on display times to the output unit 9. The output unit 9 then displays the videos at predetermined display timings determined by comparing each display time with STC counted by the counter 4.

The output time is generally called PTS (Presentation Time Stamp) and is set for attribute information for audio information and video information. In the above description, the output unit 9 controls reproduction by comparing the output time with STC counted by the counter 4. However, the decoder 5 may use the result of the comparison between STC counted by the counter 4 and the output time, as a decode timing.

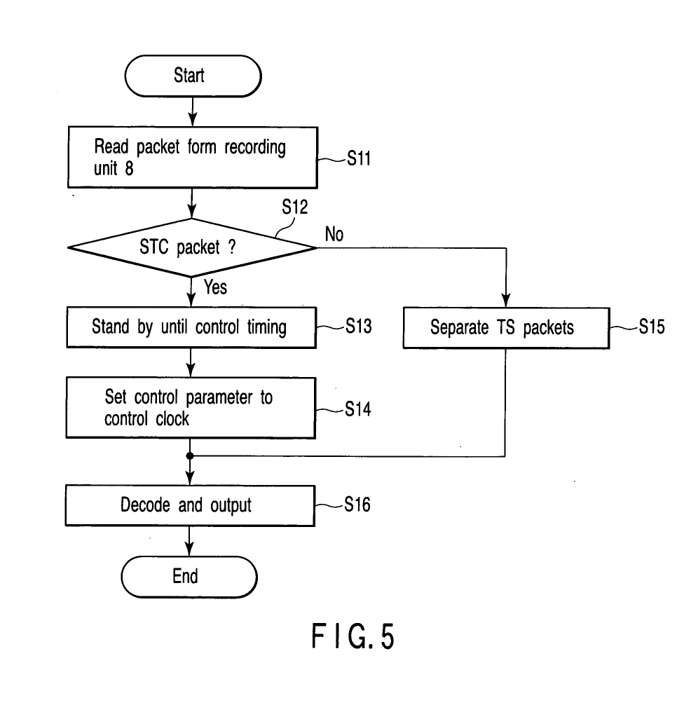

With reference to the flowchart in FIG. 5, a further detailed description will be given of a reproducing process procedure performed by the data recording and reproducing apparatus in FIG. 1.

First, the separation unit 2 reads a TS packet or STC packet from the recording unit 8 (step S11). The separation unit 2 then determines whether or not the read packet is for STC (step S12). If the read packet is for STC (Yes in step S12), the process proceeds to step S13. Otherwise (No in step S12), the process proceeds to step S15.

In step S13, the process stands by until the control timing specified in the data section of the STC packet. Then, the recording and reproducing processing unit 6 transfers the control parameter in the STC packet to the counter control unit 7, while transferring the control timing to the comparison unit 3. The comparison unit 3 compares the control timing in the STC packet with STC counted by the counter 4. On the basis of the comparison, the comparison unit 3 notifies the counter control unit 7 of a setting timing for the control parameter. Upon receiving the notification, the counter control unit 7 updates the control parameter in accordance with the setting timing and controls the clock frequency of the counter 4. The process then proceeds to step S16 (step S14).

In step S15, the separation unit 2 separates video information and audio information from the TS packets and transfers it to the decoder 5. The process proceeds to step S16.

In step S16, in accordance with the reproduced recorded reproduction clock, the decoder 5 decodes the video information and audio information and the output unit 9 outputs the decoded information. The series of steps are thus finished.

As described above, in the data recording and reproducing apparatus in accordance with the embodiment, at the time of recording, the comparison unit 3 compares PCR with STC counted by the counter 4 and outputs the difference between PCR and STC to the counter control unit 7 as a control signal. The counter control unit 7 controls the clock frequency of the counter 4 on the basis of the control signal. The counter control unit 7 further outputs information on the control parameter and control timing for this control. The recording and reproducing processing unit 6 generates and outputs STC packets each containing the control parameter and control timings. The recording unit 8 records each of the STC packets in front of each TS packet having PCR.

At the time of reproduction, the recording and reproducing processing unit 6 transfers the control parameter in each STC packet to the counter control unit 7, while transferring the control timing to the comparison unit 3. On the basis of the comparison between the control timing and STC from the counter 4, the comparison unit 3 notifies the counter control unit 7 of a setting timing for the control parameter. The counter control unit 7 updates the control parameter in accordance with the setting timing obtained. The counter control unit 7 further controls the clock frequency of the counter 4.

The data recording and reproducing apparatus in accordance with the present embodiment thus records STC control information together with TS packets. This enables the recorded reproduction clock to be easily reproduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data recording and reproducing apparatus comprising:
a separation unit configured to separate a program clock reference (PCR) from a received transport stream packet (TS packet);
a counter to count system time clocks (STCs) generated corresponding to the clock frequency;
a comparison unit configured to compare the PCR with the STC to output a difference between the PCR and the STC as a control signal;
a first control unit configured to control the clock frequency on the basis of the control signal and to output information on a control parameter and a control timing for controlling the clock frequency;
a second control unit configured to generate a system time clock packet (STC packet) containing the control parameter and the control timing as control information; and
a recording unit configured to record the TS packet and the STC packet.

2. The data recording and reproducing apparatus according to claim 1, wherein the recording unit is configured to record the STC packet in front of the TS packet having the PCR.

3. The data recording and reproducing apparatus according to claim 1, wherein the recording unit is configured to record the STC packet in a file different from a file in which the TS packet is recorded.

4. The data recording and reproducing apparatus according to claim 2, wherein the recording unit is configured to further record the STC packet at a fixed period.

5. A data recording and reproducing apparatus comprising:
a counter to count system time clocks (STCs) generated corresponding to the clock frequency;
a recording unit configured to record a transport stream packet (TS packet) and a system time clock packet (STC packet) containing a control parameter and a control timing for control of the clock frequency;
a comparison unit configured to compare the control timing with the STC to output a setting timing for the control parameter based on a comparison result;
a control unit configured to update the control parameter in accordance with the setting timing and to control the clock frequency of the counter in accordance with the updated control parameter;
a separation unit configured to separate audio information and video information from the TS packet;
a decoder to decode the audio information and the video information; and
an output unit configured to output the decoded audio information and video information at a timing determined by the STC.

6. The data recording and reproducing apparatus according to claim 5, wherein the recording unit is configured to record the STC packet in front of the TS packet having a program clock reference.

7. The data recording and reproducing apparatus according to claim 5, wherein the recording unit is configured to record the STC packet in a file different from a file in which the TS packet is recorded.

8. The data recording and reproducing apparatus according to claim 6, wherein the recording unit is configured to further record the STC packet at a fixed period.
